(19) United States
(12) Patent Application Publication
(10) Pub. No.: US 2024/0396043 A1
(43) Pub. Date: Nov. 28, 2024

(54) NEGATIVE ELECTRODE OF SECONDARY BATTERY, METHOD FOR FABRICATING THE NEGATIVE ELECTRODE, AND SECONDARY BATTERY USING THE NEGATIVE ELECTRODE

(71) Applicant: Prime Planet Energy & Solutions, Inc., Tokyo (JP)

(72) Inventor: Naoto ONODERA, Kobe-shi (JP)

(21) Appl. No.: 18/665,570

(22) Filed: May 16, 2024

(30) Foreign Application Priority Data
May 22, 2023 (JP) 2023-083565

(51) Int. Cl. H01M 4/587; H01M 4/02; H01M 4/04; H01M 4/133; H01M 4/1393

(52) U.S. Cl. CPC H01M 4/587; H01M 4/0404; H01M 4/0435; H01M 4/133; H01M 4/1393; H01M 2004/021; H01M 2004/027

(57) ABSTRACT

A negative electrode containing Si-containing particles and graphite particles and capable of suppressing capacity degradation in repetitive charge and discharge of a secondary battery is provided. The negative electrode disclosed here includes a negative electrode current collector and a negative electrode active material layer supported by the negative electrode current collector. The negative electrode active material layer contains graphite particles, first Si-containing particles, and second Si-containing particles. The first Si-containing particles have an aspect ratio larger than an aspect ratio of the second Si-containing particles. The aspect ratio of the first Si-containing particles is 4.0 to 10.0, and the aspect ratio of the second Si-containing particles is 1.0 to 3.0. A mass ratio between the first Si-containing particles and the second Si-containing particles is 10:90 to 50:50.

### TECHNICAL FIELD

The present disclosure relates to a negative electrode of a secondary battery, and a method for fabricating the negative electrode. The present disclosure also relates to a secondary battery using the negative electrode. This application claims the benefit of priority to Japanese Patent Application No. 2023-083565 filed on May 22, 2023. The entire contents of this application are hereby incorporated herein by reference.

### BACKGROUND

Recent secondary batteries are suitably used for, for example, portable power supplies for devices such as personal computers and portable terminals, and power supplies for driving vehicles such as battery electric vehicles (BEVs), hybrid electric vehicles (HEVs), and plug-in hybrid electric vehicles (PHEVs).

For application as vehicle driving power supplies, especially application as BEV driving power supplies, secondary batteries have been required to have higher capacities from the viewpoint of increasing traveling distance of vehicles. A known negative electrode active material having high capacity is Si-containing particles, and such Si-containing particles are known to achieve higher capacity of secondary batteries (see, for example, Patent Document 1). Patent Document 1 discloses a technique using both Si-containing particles and graphite particles such as natural graphite, as a negative electrode active material.

### CITATION LIST

### Patent Document

Patent Document 1: Japanese Patent Application Publication No. 2015-38862

### SUMMARY

Si-containing particles, however, have high capacity but show a large volume change due to expansion/contraction in charging and discharging a secondary battery. Thus, in the case of using both Si-containing particles and graphite particles, especially if the proportion of the Si-containing particles is large, filling property of the Si-containing particles decreases during repetitive charge and discharge of the secondary battery, resulting in possibilities of troubles such as breakage of a conductive path and occurrence of internal stress. Therefore, in the case of using both Si-containing particles and graphite particles, there arises the problem of a decrease in cycle characteristics of the secondary battery, specifically, the problem of significant capacity degradation in repetitive charge and discharge of the secondary battery.

Embodiments of the present disclosure provide a negative electrode containing Si-containing particles and graphite particles and capable of suppressing capacity degradation in repetitive charge and discharge of a secondary battery.

A negative electrode disclosed here includes a negative electrode current collector, and a negative electrode active material layer supported by the negative electrode current collector. The negative electrode active material layer contains graphite particles, first Si-containing particles, and second Si-containing particles. The first Si-containing particles have an aspect ratio larger than an aspect ratio of the second Si-containing particles. The aspect ratio of the first Si-containing particles is 4.0 to 10.0. The aspect ratio of the second Si-containing particles is 1.0 to 3.0. A mass ratio between the first Si-containing particles and the second Si-containing particles is 10:90 to 50:50.

This configuration can provide a negative electrode containing Si-containing particles and graphite particles and capable of suppressing capacity degradation in repetitive charge and discharge of the secondary battery.

In another aspect, a method for fabricating a negative electrode of a secondary battery disclosed here includes: preparing a negative electrode paste containing graphite particles, first Si-containing particles, second Si-containing particles, and a dispersion medium; applying the negative electrode paste onto a negative electrode current collector; drying the applied negative electrode paste to form a negative electrode active material layer; and pressing the negative electrode active material layer. The first Si-containing particles have an aspect ratio larger than an aspect ratio of the second Si-containing particles. The aspect ratio of the first Si-containing particles is 4.0 to 10.0. The aspect ratio of the second Si-containing particles is 1.0 to 3.0. A mass ratio between the second Si-containing particles and the first Si-containing particles is 10:90 to 50:50.

The negative electrode obtained by the configuration described above can provide a secondary battery with high resistance to capacity degradation in repetitive charge and discharge of the secondary battery.

In another aspect, a secondary battery disclosed here includes a positive electrode, a negative electrode, and an electrolyte. This negative electrode is the negative electrode described above.

This configuration can provide a secondary battery with high resistance to capacity degradation in repetitive charge and discharge.

### BRIEF DESCRIPTION OF THE DRAWINGS

FIG. 1 is a cross-sectional view schematically illustrating a configuration of a negative electrode of a secondary battery according to one embodiment of the present disclosure.

FIG. 2 is a cross-sectional view schematically illustrating a configuration of particles included in a negative electrode active material layer of the negative electrode illustrated in FIG. 1.

FIG. 3 is a cross-sectional view schematically illustrating a configuration of a lithium ion secondary battery fabricated using a negative electrode of a secondary battery according to one embodiment of the present disclosure.

FIG. 4 is a schematic disassembled view illustrating a configuration of a wound electrode body of the lithium ion secondary battery illustrated in FIG. 3.

### DETAILED DESCRIPTION

Embodiments of the present disclosure will be described hereinafter with reference to the drawings. Matters not specifically mentioned herein but required for carrying out the present disclosure can be understood as matters of design of a person skilled in the art based on related art in the field. The present disclosure can be carried out on the basis of the contents disclosed in the description and common general knowledge in the field. In the drawings, members and parts having the same functions are denoted by the same reference characters for description. Dimensional relationships (e.g., length, width, and thickness) in the drawings do not reflect actual dimensional relationships. A numerical range expressed as “A to B” herein includes A and B.

A “secondary battery” herein refers to an electricity storage device capable of being repeatedly charged and discharged. A “lithium ion secondary battery” herein refers to a secondary battery that uses lithium ions as charge carriers and performs charge and discharge by movement of charges accompanying lithium ions between positive and negative electrodes.

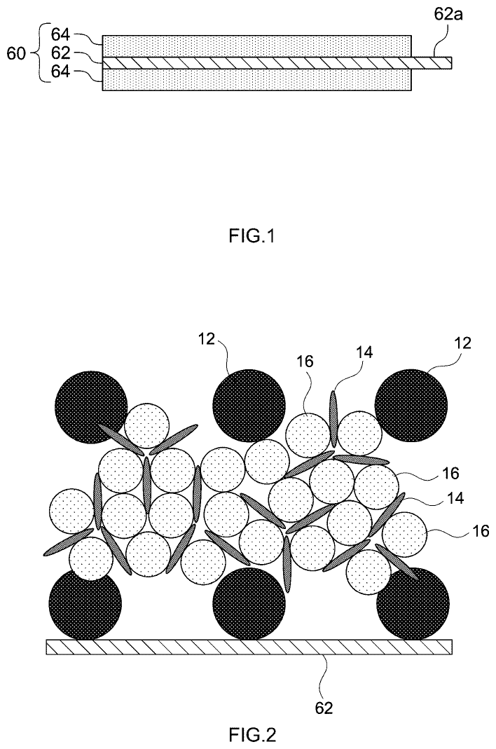

A negative electrode disclosed here is used for a secondary battery, and desirably used for a lithium ion secondary battery. One embodiment of a negative electrode disclosed here will be specifically described with reference to FIG. 1. FIG. 1 is a cross-sectional view schematically illustrating an example of a negative electrode 60 according to this embodiment and taken along a thickness direction and a width direction. The negative electrode 60 according to this embodiment illustrated in FIG. 1 is a negative electrode of a lithium ion secondary battery.

As illustrated in the drawing, the negative electrode 60 includes a negative electrode current collector 62, and a negative electrode active material layer 64 supported by the negative electrode current collector 62. In other words, the negative electrode 60 includes the negative electrode current collector 62, and the negative electrode active material layer 64 disposed on the negative electrode current collector 62. The negative electrode active material layer 64 may be provided only on one surface of the negative electrode current collector 62 or may be provided on each surface (i.e., both surfaces) of the negative electrode current collector 62 as shown in the illustrated example. The negative electrode active material layer 64 is desirably provided on each surface of the negative electrode current collector 62.

As shown in the illustrated example, a negative electrode active material layer non-formed portion 62a including no negative electrode active material layer 64 may be provided at one end of the negative electrode 60 in the width direction. In the negative electrode active material layer non-formed portion 62a, the negative electrode current collector 62 is exposed so that the negative electrode active material layer non-formed portion 62a can function as a current collecting portion. However, the structure for collecting electricity from the negative electrode 60 is not limited to this example.

The negative electrode current collector 62 has a foil shape (or a sheet shape) in the illustrated example, but is not limited to this shape. The negative electrode current collector 62 may have various forms such as a rod shape, a plate shape, or a mesh shape. The material for the negative electrode current collector 62 can be a highly conductive metal (e.g., copper, nickel, titanium, or stainless steel) in a manner the same as or similar to a conventional lithium ion secondary battery, and among these metals, copper is desirable. As the negative electrode current collector 62, copper foil is especially desirable.

Dimensions of the negative electrode current collector 62 are not particularly limited, and may be appropriately determined depending on battery design. In the case of using copper foil as the negative electrode current collector 62, the thickness of the foil is not particularly limited, and is, for example, 5 μm or more and 35 μm or less, desirably 6 μm or more and 20 μm or less.

The negative electrode active material layer 64 contains a negative electrode active material. As the negative electrode active material, at least graphite particles, first Si-containing particles having a high aspect ratio, second Si-containing particles having a low aspect ratio. This will be described in detail with reference to FIG. 2. FIG. 2 is a schematic cross-sectional view illustrating particles included in the negative electrode active material layer 64 illustrated in FIG. 1. As illustrated in FIG. 2, the negative electrode active material layer 64 includes graphite particles 12, first Si-containing particles 14 having a high aspect ratio, and second Si-containing particles 16 having a low aspect ratio.

Graphite constituting the graphite particles 12 may be natural graphite or artificial graphite, and may be amorphous carbon-coated graphite in which graphite is coated with an amorphous carbon material.

The shape of the graphite particles 12 is not particularly limited, and may be a scaly shape, a spherical shape, or the like. The graphite particles 12 are desirably spheroidized graphite particles. In the case where the graphite particles 12 are spherical, the circularity of the graphite particles 12 is desirably 0.85 to 1, more desirably 0.88 to 1, even more desirably 0.90 to 1.

It should be noted that the “circularity” herein refers to a ratio of a circumference of a complete circle having the same area as a projected area of particles to a circumference of a projected image of the particles (i.e., circularity=circumference of complete circle having the same area as projected area of particles/circumference of projected image of particles). Thus, as the circularity is closer to one, the particle projected image approaches a complete circle, and particles approach a complete sphere. The circularity can be determined by, for example, obtaining circularities of 100 or more particles with a commercially available static automated image analyzer and calculating an average of the obtained circularities.

The average particle size (D50) of the graphite particles 12 is not particularly limited. The average particle size (D50) of the graphite particles 12 is, for example, 1 μm to 30 μm, desirably 5 μm to 25 μm, more desirably 10 μm to 23 μm, even more desirably 12 μm to 20 μm.

It should be noted that the “average particle size (D50)” herein refers to a median diameter (D50), and means a particle size corresponding to a cumulative frequency of 50% by volume from the small-size particle side in volume-based particle size distribution based on a laser diffraction and scattering method. Thus, the average particle size (D50) can be determined by using, for example, a commercially available particle size distribution analyzer of a laser diffraction and scattering type.

The content of graphite particles to the total of the graphite particles 12, the first Si-containing particles 14, and the second Si-containing particles 16 is desirably 40 mass % to 90 mass %, more desirably 45 mass % to 85 mass %, even more desirably 50 mass % to 80 mass %.

As the first Si-containing particles 14 and the second Si-containing particles 16, particles of a Si-C composite material can be used, for example. The Si-C composite material typically includes a carbon domain and an Si-containing domain. Each of the first Si-containing particles 14 and the second Si-containing particles 16 may not a Si-C composite material and may be Si particles, Si oxide particles, and the like.

Examples of the carbon domain include: a carbonized material of a carbon precursor (e.g., petroleum pitch, coal pitch, and phenolic resin); and graphite. The carbon domain desirably constitute a carbon matrix. Thus, the Si-C composite material is desirably a material in which a plurality of Si-containing domains are dispersed in a carbon matrix. This case is advantageous because the carbon matrix can reduce a volume change due to expansion/contraction of the Si-containing domains.

The Si-containing domain contains Si and are constituted by a material such as Si, Si oxide (SiOₓ), Si nitride (SiNₓ), or Si carbide (SiCₓ). The Si-containing domain is desirably constituted by at least one of Si or Si oxide (SiOₓ). The Si-containing domain may be fine particles.

The average particle size of the Si-containing domains is, for example, 50 nm or less and may be 5 nm to 50 nm. It should be noted that the “average particle size of Si-containing domains” can be obtained as follows. First, the negative electrode active material layer 64 is subjected to a focused ion beam (FIB) process, thereby preparing a sample for scanning transmission electron microscopic (STEM) observation. Then, this sample is subjected to an clement analysis by EDX clement mapping, and then a bright field image (BF image) and a high-angle annular dark field image (HAADF image) are acquired. From contrasts and shapes obtained from the BF image and the HAADF image, diameters of the Si-containing domains can be determined. Then, diameters of randomly selected 10 or more Si-containing domains are obtained, and an average of the diameters is defined as an “average particle size of the Si-containing domains”.

Examples of the Si-C composite material include: a material in which fine particles containing Si are dispersed in a carbon material; and a material in which fine particles containing Si are present in voids of granulated porous graphite.

The Si content in the first Si-containing particles 14 and the Si content in the second Si-containing particles 16 are not particularly limited. Each of the Si content in the first Si-containing particles 14 and the Si content in the second Si-containing particles 16 is desirably 20 mass % to 80 mass %, more desirably 30 mass % to 70 mass %, even more desirably 40 mass % to 60 mass %. A ratio of the Si content in the first Si-containing particles 14 to the Si content in the second Si-containing particles 16 is desirably 1.0 or less.

To obtain a desirable filling state of the first Si-containing particles 14 and the second Si-containing particles 16, a mass ratio between the first Si-containing particles 14 and the second Si-containing particles 16 (the first Si-containing particles 14: the second Si-containing particles 16) is 10:90 to 50:50, desirably 15:85 to 40:60, more desirably 18:82 to 35:65, even more desirably 20:80 to 30:70.

The total content of the first Si-containing particles 14 and the second Si-containing particles 16 with respect to the total of the graphite particles 12, the first Si-containing particles 14, and the second Si-containing particles 16 is desirably 10 mass % to 60 mass %, more desirably 15 mass % to 55 mass %, even more desirably 20 mass % to 50 mass %.

The aspect ratio of the first Si-containing particles 14 is larger than the aspect ratio of the second Si-containing particles 16. The aspect ratio of the first Si-containing particles 14 is 4.0 to 10.0. The aspect ratio of the second Si-containing particles 16 is 1.0 to 3.0. Thus, each of the second Si-containing particles 16 has a spherical shape or an approximately spherical shape.

By using the first Si-containing particles 14 and the second Si-containing particles 16 described above in a predetermined mass ratio together with graphite particles, capacity degradation in repetitive charge and discharge of the secondary battery can be suppressed. This is supposed to be because of the following reasons.

In the case where the negative electrode active material layer 64 includes the first Si-containing particles 14 and the second Si-containing particles 16 described above, the first Si-containing particles 14 with a high aspect ratio fill gaps between the second Si-containing particles 16 with a low aspect ratio (i.e., having an approximately spherical shape) in a wedge-like manner, as illustrated in FIG. 2. Consequently, Si-containing particles are not easily deformed in charging and discharging of the secondary battery, and internal stress during expansion/contraction can be thereby reduced and thus, displacement of the Si-containing particles can be suppressed. In addition, breakage of conductive paths can be inhibited. In this manner, capacity degradation in repetitive charge and discharge of the secondary battery can be suppressed.

Thus, if the aspect ratio of the first Si-containing particles 14 is excessively small, the first Si-containing particles 14 do not easily enter gaps between the second Si-containing particles 16. On the other hand, if the aspect ratio of the first Si-containing particles 14 is excessively large, filling property thereof decreases. In view of this, the aspect ratio of the first Si-containing particles 14 is 4.0 to 10.0, desirably 4.5 to 9.0, more desirably 5.0 to 9.0, even more desirably 5.0 to 7.0. The first Si-containing particles 14 are desirably Si-C composite material particles in which Si-containing domains are introduced into scaly-shaped graphite or scaly-shaped graphite granules.

In a case where the second Si-containing particles 16 are excessively non-spherical, filling property thereof decreases. In view of this, the aspect ratio of the second Si-containing particles 16 is 1.0 to 3.0, desirably 1.0 to 2.0, more desirably 1.0 to 1.5, even more desirably 1.0 to 1.3. The second Si-containing particles 16 are desirably Si-C composite material particles in which Si-containing domains are introduced into spherical graphite granules.

It should be noted that the aspect ratio of particles herein refers to a ratio of a major axis diameter (i.e., a major axis length) of particles to a minor axis diameter (i.e., a minor axis length) of the particles (major axis diameter/minor axis diameter). The aspect ratios of the first Si-containing particles 14 and the second Si-containing particles 16 are determined by acquiring images of the first Si-containing particles 14 and the second Si-containing particles 16, obtaining a ratio of a major axis diameter to a minor axis diameter (major axis diameter/minor axis diameter) for each of randomly selected 100 or more particles, and calculating averages thereof. It should be noted that the aspect ratio can be easily measured with an image particle size distribution analyzer.

It should be noted that FIG. 2 is a schematic view conceptually illustrating a filling state of the first Si-containing particles 14 and the second Si-containing particles 16, and thus, arrangement of the graphite particles 12, the first Si-containing particles 14, and the second Si-containing particles 16 in the negative electrode active material layer 64 are not limited to the illustrated example. All the first Si-containing particles 14 do not need to be present between the second Si-containing particles 16 in wedge-like manner.

The sizes of the first Si-containing particles 14 and the second Si-containing particles 16 are not particularly limited. The major axis diameter (D1) of each of the first Si-containing particles 14 is, for example, 2 μm to 15 μm, desirably 4 μm to 12 μm. The major axis diameter (D2) of each of the second Si-containing particles 16 is, for example, 2 μm to 10 μm, desirably 4 μm to 8 μm.

Here, in the case where the ratio of the major axis diameter (D1) of the first Si-containing particles 14 with a high aspect ratio to the major axis diameter (D2) of the second Si-containing particles 16 with a low aspect ratio (D1/D2) is desirably not excessively high, cycle characteristics of the secondary battery can be further enhanced. This is supposed to be because the number of the first Si-containing particles filling gaps between the second Si-containing particles 16 in a wedge-like manner increases. Thus, the ratio of the major axis diameter (D1) of the first Si-containing particles 14 to the major axis diameter (D2) of the second Si-containing particles 16 (D1/D2) is desirably 2 or less, more desirably 1.5 or less, even more desirably 1.0 or less. The ratio (DI/D2) may be 0.5 or more, 0.7 or more, or 0.8 or more.

The major axis diameter (D1) of the first Si-containing particles 14 and the major axis diameter (D2) of the second Si-containing particles 16 can be determined by acquiring images of the first Si-containing particles 14 and the second Si-containing particles 16, obtaining major axis diameters of randomly selected 100 or more particles, and calculating averages thereof. It should be noted that the major axis diameter (D1) and the major axis diameter (D2) can be easily measured by an image particle size distribution analyzer.

The first Si-containing particles 14 and the second Si-containing particles 16 can be produced in accordance with a known method. Various methods for producing particles of the Si-C composite material are known (see, for example, Japanese Patent Application Publication No. 2015-38862, International Patent Publication No. 2014/046144, and prior art documents listed in this International Patent Publication).

The negative electrode active material layer 64 may contain components other than the negative electrode active material, and examples of the components include a binder and a conductive material. Examples of the binder include styrene-butadiene rubber (SBR), carboxymethyl cellulose (CMC), polyacrylic acid (PAA), and polyvinylidene fluoride (PVDF). CMC also functions as a thickener. Examples of the conductive material include carbon black such as acetylene black, carbon fibers, and carbon nanotubes (CNTs). Among these, CNTs are desirable. In the case of using CNTs as the conductive material, the negative electrode active material layer 64 may contain a disperser of CNTs.

The content of the negative electrode active material in the negative electrode active material layer 64 (i.e., with respect to the total mass of the negative electrode active material layer 64) is desirably 90 mass % or more, more desirably 95 mass % or more. The content of the binder in the negative electrode active material layer 64 is desirably 0.1 mass % or more and 8 mass % or less, more desirably 0.5 mass % or more and 5 mass % or less. The content of the conductive material in the negative electrode active material layer 64 is desirably 0.01 mass % or more and 3 mass % or less, more desirably 0.05 mass % or more and 1 mass % or less.

The thickness of the negative electrode active material layer 64 is not particularly limited, and is, for example, 10 μm or more and 400 μm or less, desirably 20 μm or more and 300 μm or less.

The density of the negative electrode active material layer 64 is not particularly limited, and is, for example, 0.7 g/cm³ or more, desirably 1.0 g/cm³ or more, more desirably 1.2 g/cm³ or more. On the other hand, the density of the negative electrode active material layer 64 is, for example, 2.3 g/cm³ or less, may be 2.0 g/cm³ or less.

The negative electrode 60 may include a member other than the negative electrode current collector 62 and the negative electrode active material layer 64. For example, an insulating layer (not shown) adjacent to the negative electrode active material layer 64 may be disposed on the negative electrode active material layer non-formed portion 62a. The insulating layer contains, for example, insulating inorganic fillers.

The negative electrode 60 can be desirably fabricated by a production method including the steps of: preparing a negative electrode paste containing the graphite particles 12, the first Si-containing particles 14, the second Si-containing particles 16, and the dispersion medium (hereinafter also referred to as a “paste preparation step”); applying the prepared negative electrode paste onto the negative electrode current collector 62 (hereinafter also referred to as an “application step”); drying the applied negative electrode paste to form a negative electrode active material layer 64 (hereinafter also referred to as a “drying step”); and pressing the negative electrode active material layer 64 (hereinafter also referred to as a “pressing step”). The first Si-containing particles 14 has an aspect ratio larger than an aspect ratio of the second Si-containing particles 16, and the aspect ratio of the first Si-containing particles 14 is 4.0 to 10.0, and the aspect ratio of the second Si-containing particles 16 is 1.0 to 3.0. The mass ratio between the first Si-containing particles and the second Si-containing particles is 10:90 to 50:50.

It should be noted that the “paste” herein refers to a mixture in which a solid content is partially or entirely dispersed in a dispersion medium, and encompasses so-called “slurry,” “ink,” and the like.

In the paste preparation step, first, the first Si-containing particles 14 with an aspect ratio of 4.0 to 10.0, and the second Si-containing particles 16 with an aspect ratio of 1.0 to 3.0 are prepared. At this time, the first Si-containing particles and the second Si-containing particles are measured to have a mass ratio of 10:90 to 50:50.

The paste preparation can be performed in accordance with a known method by mixing the graphite particles 12, the first Si-containing particles 14, the second Si-containing particles 16, and optional components (e.g., a binder, a conductive material, etc.) with a dispersion medium (e.g., water) with a known mixer, a stirrer, or the like. Desirably, the first Si-containing particles 14 and the second Si-containing particles 16 are preliminarily mixed by dry blending, and using the obtained preliminary mixture, a negative electrode paste is prepared. By preliminarily mixing the first Si-containing particles 14 and the second Si-containing particles 16, the filling state of the first Si-containing particles 14 and the second Si-containing particles 16 in the negative electrode active material layer 64 improves, so that cycle characteristics can be thereby further enhanced. The preliminary mixing is desirably performed such that the first Si-containing particles 14 and the second Si-containing particles 16 are uniformly mixed.

The preliminary mixing by dry blending the first Si-containing particles 14 and the second Si-containing particles 16 can be performed in accordance with a known method. For example, the preliminary mixing can be performed with a mixer including impellers (e.g., a disper, a tumbler mixer, a Henschel mixer, or a ribbon mixer), a nauta mixer, or other mixers so that the first Si-containing particles 14 and the second Si-containing particles 16 are uniformly mixed. The obtained preliminary mixture, graphite particles, and optional components (e.g., a binder and a conductive material) are mixed with a dispersion medium (e.g., water), and thereby a negative electrode paste can be obtained.

The application step can be performed in accordance with a known method. Specifically, for example, the application step can be performed in such a manner that the obtained negative electrode paste is applied onto the negative electrode current collector 62 with an application device such as a gravure coater, a comma coater, a slit coater, or a die coater.

The drying step can be performed in accordance with a known method. Specifically, for example, the dispersion medium is removed, with a drier such as a drying furnace, from the negative electrode current collector 62 onto which the negative electrode paste has been applied, thereby forming the negative electrode active material layer 64. In this manner, the drying step can be performed. A drying time and a drying temperature may be determined as appropriate in accordance with a solid content of the negative electrode paste, and the drying time and the drying temperature are not particularly limited. The drying temperature is, for example, 60° C. or more and 200° C. or less, desirably 70° C. or more and 150° C. or less. The drying time is, for example, 10 seconds or more and 30 minutes or less, desirably 30 seconds or more and 10 minutes or less.

The pressing step can be performed in accordance with a known method. Specifically, a pressure is applied onto the formed negative electrode active material layer 64 with, for example, a roller press, thereby performing the pressing step. Through the pressing step, the graphite particles 12, the first Si-containing particles 14, and the second Si-containing particles 16 are densely filled, and the number of first Si-containing particles 14 filling gaps between the second Si-containing particles 16 in a wedge-like manner increases. In this manner, the negative electrode 60 is obtained.

The negative electrode 60 according to this embodiment can provide a secondary battery with high resistance to capacity degradation in repetitive charge and discharge of the secondary battery. In addition, since the negative electrode 60 according to this embodiment uses the negative electrode active material containing Si, capacity of the secondary battery can be increased. Accordingly, the secondary battery using the negative electrode 60 according to this embodiment has high capacity and exhibits excellent cycle characteristics.

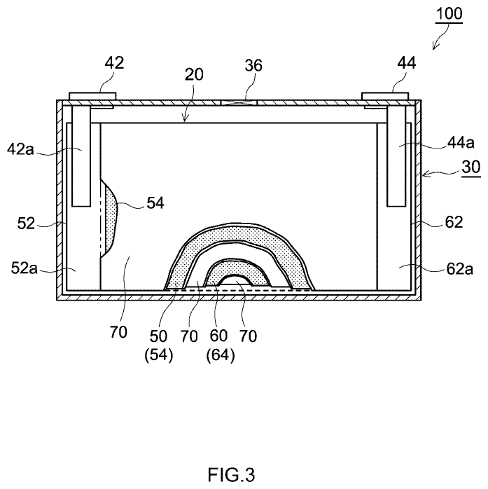

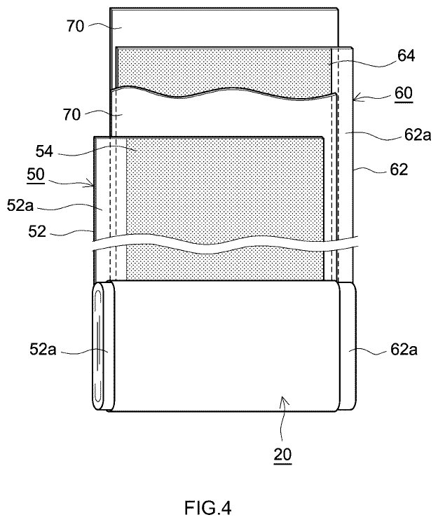

In another aspect, a secondary battery disclosed here includes a positive electrode, a negative electrode, and an electrolyte. This negative electrode is the negative electrode 60 according to the embodiment described above. An embodiment of the secondary battery disclosed here will be described with reference to FIGS. 3 and 4 using a lithium ion secondary battery as an example. The following configuration example is a flat square lithium ion secondary battery including a flat wound electrode body and a flat battery case.

A lithium ion secondary battery 100 illustrated in FIG. 3 is a sealed lithium ion secondary battery 100 in which a flat wound electrode body 20 and a nonaqueous electrolyte (not shown) are housed in a flat square battery case (i.e., outer container) 30. The battery case 30 includes a positive electrode terminal 42 and a negative electrode terminal 44 for external connection, and a thin safety valve 36 configured such that when the internal pressure of the battery case 30 increases to a predetermined level or more, the safety valve 36 releases the internal pressure. The battery case 30 has an injection port (not shown) for injecting the nonaqueous electrolyte. The positive electrode terminal 42 is electrically connected to a positive electrode current collector plate 42a. The negative electrode terminal 44 is electrically connected to a negative electrode current collector plate 44a. A material for the battery case 30 is, for example, a metal material that is lightweight and has high thermal conductivity, such as aluminum.

As illustrated in FIGS. 3 and 4, in the wound electrode body 20, a positive electrode sheet 50 and a negative electrode sheet 60 are stacked with two long separator sheets 70 interposed therebetween and wound in the longitudinal direction. In the positive electrode sheet 50, a positive electrode active material layer 54 is formed on one or each (each in this example) surface of a long positive electrode current collector 52 along the longitudinal direction. In the negative electrode sheet 60, a negative electrode active material layer 64 is formed on one or each (each in this example) surface of a long negative electrode current collector 62 along the longitudinal direction. A positive electrode active material layer non-formed portion 52a (i.e., a portion where no positive electrode active material layer 54 is formed and the positive electrode current collector 52 is exposed) and a negative electrode active material layer non-formed portion 62a (i.e., a portion where no negative electrode active material layer 64 is formed and the negative electrode current collector 62 is exposed) extend off outward from both ends of the wound electrode body 20 in the winding axis direction (i.e., sheet width direction orthogonal to the longitudinal direction). The positive electrode current collector plate 42a and the negative electrode current collector plate 44a are respectively joined to the positive electrode active material layer non-formed portion 52a and the negative electrode active material layer non-formed portion 62a.

The positive electrode current collector 52 constituting the positive electrode sheet 50 may be a known positive electrode current collector for use in a lithium ion secondary battery, and examples of the positive electrode current collector 52 include sheets or foil of highly conductive metals (e.g., aluminum, nickel, titanium, and stainless steel). The positive electrode current collector 52 is desirably aluminum foil.

Dimensions of the positive electrode current collector 52 are not particularly limited, and may be appropriately determined depending on battery design. In the case of using aluminium foil as the positive electrode current collector 52, the thickness thereof is not particularly limited, and is, for example, 5 μm or more and 35 μm or less, desirably 7 μm or more and 20 μm or less.

The positive electrode active material layer 54 contains a positive electrode active material. The positive electrode active material may be a positive electrode active material having a known composition for use in a lithium ion secondary battery. Specifically, as the positive electrode active material, a lithium composite oxide or a lithium transition metal phosphate compound, for example, may be used. The crystal structure of the positive electrode active material is not particularly limited, and may be, for example, a layered structure, a spinel structure, or an olivine structure.

The lithium composite oxide is desirably a lithium transition metal composite oxide including at least one of Ni, Co, or Mn as a transition metal element, and specific examples of the lithium transition metal composite oxide include a lithium nickel composite oxide, a lithium cobalt composite oxide, a lithium manganese composite oxide, a lithium nickel manganese composite oxide, a lithium nickel cobalt manganese composite oxide, a lithium nickel cobalt aluminum composite oxide, and a lithium iron nickel manganese composite oxide.

It should be noted that the “lithium nickel cobalt manganese composite oxide” herein includes not only oxides including Li, Ni, Co, Mn, and O as constituent elements, but also an oxide further including one or more additive elements besides them. Examples of the additive elements include transition metal elements and typical metal elements such as Mg, Ca, Al, Ti, V, Cr, Y, Zr, Nb, Mo, Hf, Ta, W, Na, Fe, Zn, and Sn. The additive element may be a metalloid element such as B, C, Si, or P, and a nonmetal clement such as S, F, Cl, Br, or I. This also applies, in the same manner, to the lithium nickel composite oxide, the lithium cobalt composite oxide, the lithium manganese composite oxide, the lithium nickel manganese composite oxide, the lithium nickel cobalt aluminium composite oxide, and the lithium iron nickel manganese composite oxide described above.

Examples of the lithium transition metal phosphate compound include lithium iron phosphate (LiFePO₄), lithium manganese phosphate (LiMnPO₄), and lithium manganese iron phosphate.

These positive electrode active materials can be used alone or two or more of them may be used in combination. The positive electrode active material is especially desirably the lithium nickel cobalt manganese composite oxide because of excellent characteristics such as initial resistance characteristic.

An average particle size (D50) of the positive electrode active material is not particularly limited, and is, for example, 0.05 μm or more and 25 μm or less, desirably 1 μm or more and 20 μm or less, more desirably 3 μm or more and 15 μm or less.

The positive electrode active material layer 54 may include components other than the positive electrode active material, such as trilithium phosphate, a conductive agent, and a binder. Desired examples of the conductive agent include: carbon black such as acetylene black (AB); carbon fibers such as vapor grown carbon fibers (VGCFs) and carbon nanotubes (CNTs); and other carbon materials (e.g., graphite). Examples of the binder include polyvinylidene fluoride (PVdF).

The content of the positive electrode active material in the positive electrode active material layer 54 (i.e., content of the positive electrode active material with respect to the total mass of the positive electrode active material layer 54) is not particularly limited, and is desirably 70 mass % or more, more desirably 80 mass % or more, even more desirably 85 mass % or more and 99 mass % or less. The content of trilithium phosphate in the positive electrode active material layer 54 is not particularly limited, and is desirably 0.1 mass % or more and 15 mass % or less, more desirably 0.2 mass % or more and 10 mass % or less. The content of the conductive material in the positive electrode active material layer 54 is not particularly limited, and is desirably 0.1 mass % or more and 20 mass % or less, more desirably 0.3 mass % or more and 15 mass % or less. The content of the binder in the positive electrode active material layer 54 is not particularly limited, and is desirably 0.4 mass % or more and 15 mass % or less, more desirably 0.5 mass % or more and 10 mass % or less.

The thickness of the positive electrode active material layer 54 at one side is not particularly limited, and is usually 10 μm or more, desirably 20 μm or more. On the other hand, this thickness is usually 400 μm or less, desirably 300 μm or less.

As the negative electrode sheet 60, the negative electrode 60 described above is used.

Examples of the separators 70 include a porous sheet (film) of a resin such as polyethylene (PE), polypropylene (PP), polyester, cellulose, or polyamide. The porous sheet may have a single-layer structure or a laminated structure of two or more layers (e.g., three-layer structure in which PP layers are stacked on both surfaces of a PE layer). A heat-resistance layer (HRL) may be provided on a surface of each separator 70.

The thickness of the separator 70 is not particularly limited, and is, for example, 5 μm or more and 50 μm or less, desirably 10 μm or more and 30 μm or less. An air permeability of the separators 70 obtained by a Gurley permeability test is not particularly limited, and is desirably 350 sec./100 cc or less.

The nonaqueous electrolyte typically contains a nonaqueous solvent and a supporting electrolyte (electrolyte salt). As the nonaqueous solvent, various organic solvents such as carbonates, ethers, esters, nitriles, sulfones, and lactones for use in an electrolyte of a typical lithium ion secondary battery can be used without any particular limitation. Among these, carbonates are desirable, and specific examples of the carbonates include ethylene carbonate (EC), propylene carbonate (PC), diethyl carbonate (DEC), dimethyl carbonate (DMC), ethyl methyl carbonate (EMC), monofluoroethylene carbonate (FEC), difluoroethylene carbonate (DFEC), monofluoromethyl difluoromethyl carbonate (F-DMC), and trifluorodimethyl carbonate (TFDMC). Such nonaqueous solvents may be used alone or two or more of them may be used in combination. As an example, the nonaqueous solvent consists only of carbonates. As another example, the nonaqueous solvent contains carbonates and esters such as methyl acetate.

Desired examples of the supporting electrolyte include lithium salts (desirably LiPF₆) such as LiPF₆, LiBF₄, and lithium bis(fluorosulfonyl)imide (LiFSI). The concentration of the supporting electrolyte is desirably 0.7 mol/L or more and 1.3 mol/L or less.

The nonaqueous electrolyte may include components not described above, for example, various additives exemplified by: a film forming agent such as vinylene carbonate (VC) and an oxalato complex; a gas generating agent such as biphenyl (BP) or cyclohexylbenzene (CHB); and a thickener, as long as the effects of the present disclosure are not significantly impaired.

In the lithium ion secondary battery 100, capacity degradation in repetitive charge and discharge is suppressed and capacity is high. The lithium ion secondary battery 100 is applicable to various applications. Examples of desired applications include drive power supplies to be mounted on vehicles such as battery electric vehicles (BEVs), hybrid electric vehicles (HEVs), and plug-in hybrid electric vehicles (PHEVs). The lithium ion secondary battery 100 can be used as a storage battery for, for example, a small-size power storage device. The lithium ion secondary battery 100 can be used in a form of a battery module in which a plurality of batteries are typically connected in series and/or in parallel.

The foregoing description is directed to the square lithium ion secondary battery 100 including the flat wound electrode body 20 as an example. Alternatively, the lithium ion secondary battery can also be configured as a lithium ion secondary battery including a stacked-type electrode body (i.e., electrode body in which a plurality of positive electrodes and a plurality of negative electrodes are alternately stacked). The lithium ion secondary battery can also be configured as a cylindrical lithium ion secondary battery or a laminated-case lithium ion secondary battery.

In accordance with a known method, the lithium ion secondary battery 100 can also be configured as an all-solid-state lithium ion secondary battery using a solid electrolyte instead of the nonaqueous electrolyte.

The negative electrode 60 according to this embodiment is suitable as a negative electrode of a lithium ion secondary battery, and is also configured and used as negative electrodes of other secondary batteries. These other secondary batteries can be configured in accordance with a known method.

Examples of the present disclosure will now be described in detail, but are not intended to limit the present disclosure to these examples.

### Production of Negative Electrode

### Example 1

As negative electrode active materials, the following materials were prepared. The major axis diameters and the aspect ratios of first Si-containing particles and second Si-containing particles were measured with an image particle size distribution analyzer. The Si contents of the first Si-containing particles and the second Si-containing particles were measured with a commercially available ICP analyzer.

first Si-containing particles: Si-C composite material, aspect ratio=7, major axis diameter=6 μm, Si content=48 mass %
second Si-containing particles: Si-C composite material, aspect ratio=1.2, major axis diameter=6 μm, Si content=53 mass %
graphite particles: average particle size (D50)=13 μm

As binders, carboxymethyl cellulose (CMC), polyacrylic acid (PAA), and styrene-butadiene rubber (SBR) were prepared. As a conductive material, a dispersion of single-walled carbon nanotubes (SWCNTs) was prepared.

A negative electrode paste containing graphite particles, first Si-containing particles, second Si-containing particles, CMC, PAA, SBR, and SWCNTs at a mass ratio of 60:8:32:1:1:2:0.1 was prepared in the following procedure. First, the first Si-containing particles and the second Si-containing particles were dry blended at a rotation speed of 3000 rpm with a disper to be thereby uniformly preliminarily mixed.

The obtained preliminary mixture, graphite particles, CMC, and PAA were dry blended at a rotation speed of 60 rpm with a planetary mixer. The obtained mixture, the SWCNT dispersion, and a dispersion medium were kneaded with a planetary mixer. To the resulting mixture, SBR and an additional dispersion medium were added and uniformly mixed therewith, thereby preparing a negative electrode paste.

The obtained negative electrode paste was applied onto a surface of copper foil with a thickness of 10 μm and dried, thereby forming a negative electrode active material layer. After the negative electrode active material layer had been roll pressed, the resulting sheet was processed into a predetermined size, thereby obtaining a negative electrode sheet.

### Example 2

A negative electrode sheet of Example 2 was obtained in the same manner as Example 1 except that Si-C composite material particles having an aspect ratio of 5, a major axis diameter of 5 μm, and a Si content of 50 mass % were used as first Si-containing particles and a mass ratio of a solid content of negative electrode paste was changed to graphite particles:first Si-containing particles:second Si-containing particles:CMC:PAA:SBR:SWCNT=60:12:28:1:1:2:0.1.

### Example 3

A negative electrode sheet of Example 3 was obtained in the same manner as Example 1 except that Si-C composite material particles having an aspect ratio of 7, a major axis diameter of 10 μm, and a Si content of 52 mass % were used as first Si-containing particles.

### Example 4

A negative electrode sheet of Example 4 was obtained in the same manner as Example 1 except that in preparing a negative electrode paste, first Si-containing particles and second Si-containing particles were not preliminarily mixed, and graphite particles, first Si-containing particles, second Si-containing particles, CMC, and PAA were dry blended at a rotation speed of 60 rpm with a planetary mixer.

### Comparative Example 1

A negative electrode sheet of Comparative Example 1 was obtained in the same manner as Example 1 except that Si-C composite material particles having an aspect ratio of 2,a major axis diameter of 7 μm, and a Si content of 51 mass % were used as first Si-containing particles.

### Comparative Example 2

A negative electrode sheet of Comparative Example 2 was obtained in the same manner as Example 1 except that Si-C composite material particles having an aspect ratio of 5, a major axis diameter of 5 μm, and a Si content of 50 mass % were used as first Si-containing particles and a mass ratio of a solid content of a negative electrode paste was changed to graphite particles:first Si-containing particles:second Si-containing particles:CMC:PAA:SBR:SWCNTs=60:2:38:1:1:2:0.1.

### Comparative Example 3

A negative electrode sheet of Comparative Example 3 was obtained in the same manner as Example 1 except that Si-C composite material particles having an aspect ratio of 5, a major axis diameter of 5 μm, and a Si content of 50 mass % were used as first Si-containing particles and a mass ratio of a solid content of a negative electrode paste was changed to graphite particles:first Si-containing particles:second Si-containing particles:CMC:PAA:SBR:SWCNTs=60:24:16:1:1:2:0.1.

### Comparative Example 4

A negative electrode sheet of Comparative Example 4 was obtained in the same manner as Example 1 except that a mass ratio of a solid content of a negative electrode paste was changed to graphite particles:first Si-containing particles:second Si-containing particles:CMC:PAA:SBR:SWCNTs=60:40:0:1:1:2:0.1.

### Comparative Example 5

A negative electrode sheet of Comparative Example 5 was obtained in the same manner as Example 1 except that a mass ratio of a solid content of a negative electrode paste was changed to graphite particles:first Si-containing particles:second Si-containing particles:CMC:PAA:SBR:SWCNTs=60:0:40:1:1:2:0.1.

### Fabrication of Evaluation Lithium Ion Secondary Battery

First, LiNi_{1/3}Co_{1/3}Mn_{1/3}O₂ (NCM) as positive electrode active material powder, acetylene black (AB) as a conductive material, and polyvinylidene fluoride (PVdF) as a binder were mixed with N-methylpyrrolidone (NMP) at a mass ratio of NCM:AB:PVdF=100:1:1, thereby preparing a positive electrode paste. This paste was applied onto a surface of aluminum foil with a thickness of 15 μm and dried, thereby forming a positive electrode active material layer. After the positive electrode active material layer had been roll pressed, the resulting sheet was processed into a predetermined size, thereby obtaining a positive electrode sheet.

Porous polyolefin separators were prepared. Leads are attached to the negative electrode sheet and the positive electrode sheet thus obtained, and the negative and positive electrode sheets are stacked with the separators interposed therebetween, thereby producing an electrode body. The electrode body and a nonaqueous electrolyte were housed in a case of an aluminium laminated film. As the nonaqueous electrolyte, an electrolyte was used in which LiPF₆ as a supporting electrolyte was dissolved at a concentration of 1.0 mol/L in a mixed solvent including ethylene carbonate (EC), fluoroethylene carbonate (FEC), ethyl methyl carbonate (EMC), and dimethyl carbonate (DMC) at a volume ratio of 15:5:40:40. Thereafter, the case was sealed, thereby obtaining an evaluation lithium ion secondary battery.

### Cycle Characteristic Evaluation

Each evaluation lithium ion secondary battery fabricated as described above was placed in an environment at 25° C. The evaluation lithium ion secondary battery was charged to 4.2 V with a constant current at a current value of 0.4 C, and then, charged with a constant voltage to a current value of 0.1 C. Thereafter, the evaluation lithium ion secondary battery was discharged to 2.5 V with a constant current at a current value of 0.4 C. A discharge capacity at this time was measured to obtain an initial capacity.

This charge and discharge process was defined as one cycle, and 200 cycles of the charge and discharge processes were performed. A discharge capacity after 200 cycles was obtained in a manner similar to that for the initial capacity. As an index of characteristics, a capacity retention rate (%) was obtained from (discharge capacity after 200 cycles of charge and discharge process/initial capacity)×100. Table 1 shows the results.

TABLE 1

| | Aspect ratio | | Major axis diameter | | | | | Cycle |
|---|---|---|---|---|---|---|---|---|
| | First | Second | First Si- | Second Si- | | Si-containing | Si-containing | characteristics |
| | Si- | Si- | containing | containing | | particles | particle | Capacity |
| | containing | containing | particles | particles | | preliminary | mass ratio | retention |
| | particles | particles | D1 (μm) | D2 (μm) | D1/D2 | mixing | First:Second | rate (%) |
| Example 1 | 7 | 1.2 | 6 | 6 | 1.00 | Yes | 20:80 | 89 |
| Example 2 | 5 | 1.2 | 5 | 6 | 0.83 | Yes | 30:70 | 87 |
| Example 3 | 7 | 1.2 | 10 | 6 | 1.67 | Yes | 20:80 | 83 |
| Example 4 | 7 | 1.2 | 6 | 6 | 1.00 | No | 20:80 | 84 |
| Comparative | 2 | 1.2 | 7 | 6 | 1.17 | Yes | 20:80 | 77 |
| Example 1 | | | | | | | | |
| Comparative | 5 | 1.2 | 5 | 6 | 0.83 | Yes | 5:95 | 78 |
| Example 2 | | | | | | | | |
| Comparative | 5 | 1.2 | 5 | 6 | 0.83 | Yes | 60:40 | 73 |
| Example 3 | | | | | | | | |
| Comparative | 7 | — | 6 | — | — | — | 100:0 | 68 |
| Example 4 | | | | | | | | |
| Comparative | — | 1.2 | — | 6 | — | — | 0:100 | 75 |
| Example 5 | | | | | | | | |

Results of Table 1 show that the capacity retention rate after 200 cycles of charge and discharge processes is significantly high in a case where the aspect ratio of the first Si-containing particles is 4.0 to 10.0, the aspect ratio of the second Si-containing particles is 1.0 to 3.0, and the mass ratio between the first Si-containing particles and the second Si-containing particles is 10:90 to 50:50. This demonstrates that the negative electrode disclosed here can suppress capacity degradation in repetitive charge and discharge of the secondary battery.

Specific examples of the present disclosure have been described in detail hereinbefore, but are merely illustrative examples, and are not intended to limit the scope of claims. The techniques described in claims include various modifications and changes of the above exemplified specific examples.

That is, the negative electrode of the secondary battery, the method for fabricating the negative electrode, and the second battery disclosed here are Items [1] to [9].
[1] A negative electrode including:
   a negative electrode current collector; and
   a negative electrode active material layer supported by the negative electrode current collector, wherein
   the negative electrode active material layer contains graphite particles, first Si-containing particles, and second Si-containing particles,
   the first Si-containing particles have an aspect ratio larger than an aspect ratio of the second Si-containing particles,
   the aspect ratio of the first Si-containing particles is 4.0 to 10.0,
   the aspect ratio of the second Si-containing particles is 1.0 to 3.0, and
   a mass ratio between the first Si-containing particles and the second Si-containing particles is 10:90 to 50:50.
[2] The negative electrode according to Item [1], wherein a ratio of a major axis diameter of the first Si-containing particles to a major axis diameter of the second Si-containing particles 1.5 or less.
[3] The negative electrode according to Item [1], wherein a ratio of a major axis diameter of the first Si-containing particles to a major axis diameter of the second Si-containing particles 1.0 or less.
[4] The negative electrode according to any one of Items [1] to [3], wherein the first Si-containing particles have a major axis diameter of 4 μm to 12 μm, and the second Si-containing particles have a major axis diameter of 2 μm to 10 μm.
[5] The negative electrode according to any one of Items [1] to [4], wherein the aspect ratio of the first Si-containing particles is 5.0 to 9.0, and the aspect ratio of the second Si-containing particles is 1.0 to 2.0.
[6] The negative electrode according to any one of Items [1] to [5], wherein a content of the graphite particles with respect to a total of the graphite particles, the first Si-containing particles, and the second Si-containing particles is 40 mass % to 90 mass %.
[7] A method for fabricating a negative electrode of a secondary battery, the method including:
   preparing a negative electrode paste containing graphite particles, first Si-containing particles, second Si-containing particles, and a dispersion medium;
   applying the negative electrode paste onto a negative electrode current collector;
   drying the applied negative electrode paste to form a negative electrode active material layer; and
   pressing the negative electrode active material layer, wherein
   the first Si-containing particles have an aspect ratio larger than an aspect ratio of the second Si-containing particles,
   the aspect ratio of the first Si-containing particles is 4.0 to 10.0,
   the aspect ratio of the second Si-containing particles is 1.0 to 3.0, and
   a mass ratio between the first Si-containing particles and the second Si-containing particles is 10:90 to 50:50.
[8] The method according to Item [7], wherein, in the preparing the negative electrode paste, the first Si-containing particles and the second Si-containing particles are preliminarily mixed by dry blending to obtain a preliminary mixture, and the preliminary mixture is used for preparing the negative electrode paste.
[9] A secondary battery including:
   a positive electrode;
   a negative electrode; and
   an electrolyte, wherein
   the negative electrode is the negative electrode according to any one of Items [1] to [6].

What is claimed is:

1. A negative electrode comprising:
a negative electrode current collector; and
a negative electrode active material layer supported by the negative electrode current collector, wherein
the negative electrode active material layer contains graphite particles, first Si-containing particles, and second Si-containing particles,
the first Si-containing particles have an aspect ratio larger than an aspect ratio of the second Si-containing particles,
the aspect ratio of the first Si-containing particles is 4.0 to 10.0,
the aspect ratio of the second Si-containing particles is 1.0 to 3.0, and
a mass ratio between the first Si-containing particles and the second Si-containing particles is 10:90 to 50:50.

2. The negative electrode according to claim 1, wherein a ratio of a major axis diameter of the first Si-containing particles to a major axis diameter of the second Si-containing particles 1.5 or less.

3. The negative electrode according to claim 1, wherein a ratio of a major axis diameter of the first Si-containing particles to a major axis diameter of the second Si-containing particles 1.0 or less.

4. The negative electrode according to claim 1, wherein the first Si-containing particles have a major axis diameter of 4 μm to 12 μm, and the second Si-containing particles have a major axis diameter of 2 μm to 10 μm.

5. The negative electrode according to claim 1, wherein the aspect ratio of the first Si-containing particles is 5.0 to 9.0, and the aspect ratio of the second Si-containing particles is 1.0 to 2.0.

6. The negative electrode according to claim 1, wherein a content of the graphite particles with respect to a total of the graphite particles, the first Si-containing particles, and the second Si-containing particles is 40 mass % to 90 mass %.

7. A method for fabricating a negative electrode of a secondary battery, the method comprising:
preparing a negative electrode paste containing graphite particles, first Si-containing particles, second Si-containing particles, and a dispersion medium;
applying the negative electrode paste onto a negative electrode current collector;
drying the applied negative electrode paste to form a negative electrode active material layer; and
pressing the negative electrode active material layer, wherein
the first Si-containing particles have an aspect ratio larger than an aspect ratio of the second Si-containing particles,
the aspect ratio of the first Si-containing particles is 4.0 to 10.0,
the aspect ratio of the second Si-containing particles is 1.0 to 3.0, and
a mass ratio between the first Si-containing particles and the second Si-containing particles is 10:90 to 50:50.

8. The method according to claim 7, wherein, in the preparing the negative electrode paste, the first Si-containing particles and the second Si-containing particles are preliminarily mixed by dry blending to obtain a preliminary mixture, and the preliminary mixture is used for preparing the negative electrode paste.

9. A secondary battery comprising:
a positive electrode;
a negative electrode; and
an electrolyte, wherein
the negative electrode is the negative electrode according to claim 1.
